(19) United States
(12) Patent Application Publication
(10) Pub. No.: US 2022/0010402 A1
(43) Pub. Date: Jan. 13, 2022

(54) GRAIN-ORIENTED ELECTRICAL STEEL SHEET AND MANUFACTURING METHOD THEREFOR

(71) Applicant: POSCO, Pohang-si, Gyeongsangbuk-do (KR)

(72) Inventors: Hyung Don JOO, Pohang-si, Gyeongsangbuk-do (KR); Kyung-Jun KO, Pohang-si, Gyeongsangbuk-do (KR); Chang Soo PARK, Pohang-si, Gyeongsangbuk-do (KR); Jae Kyoum KIM, Pohang-si, Gyeongsangbuk-do (KR); Sang-Woo LEE, Pohang-si, Gyeongsangbuk-do (KR); Jin-Wook SEO, Pohang-si, Gyeongsangbuk-do (KR)

(21) Appl. No.: 17/297,114

(22) PCT Filed: Nov. 28, 2019
(86) PCT No.: PCT/KR2019/016614

§ 371 Date: May 26, 2021

(30) Foreign Application Priority Data
Nov. 30, 2019 (KR) 10-2018-0153085

(51) Int. Cl. C21D 9/46; C21D 6/00; C21D 8/12; C22C 38/60; C22C 38/08; C22C 38/00; C22C 38/02; C22C 38/06; H01F 1/147

(52) U.S. Cl. CPC C21D 9/46; C22C 2202/02; C21D 8/1222; C21D 8/1233; C21D 8/1272; C21D 6/005; C22C 38/60; C22C 38/08; C22C 38/008; C22C 38/002; C22C 38/02; C22C 38/06; H01F 1/14766; C21D 2201/05; C21D 2241/00; C21D 6/008

(57) ABSTRACT

A grain-oriented electrical steel sheet according to an embodiment of the present invention includes: in wt %, Si at 1.0 to 7.0%, Mn at 0.5% or less (excluding 0%), Al at 0.005% or less (excluding 0%), S at 0.0055% or less (excluding 0%), one or more of Ba and Y at 0.005 to 0.5%, one or more of Sn at 0.02 to 0.15%, Sb at 0.01 to 0.08%, and Ni at 0.02 to 0.5%, and the balance of Fe and inevitable impurities.

### TECHNICAL FIELD

The present invention relates to a grain-oriented electrical steel sheet and a manufacturing method thereof. Specifically, the present invention relates to a grain-oriented electrical steel sheet and a manufacturing method thereof that may improve magnetism by using a recrystallized grain growth inhibition effect of Ba and Y.

### BACKGROUND ART

A grain-oriented electrical steel sheet is a soft magnetic material having excellent magnetic properties in a rolling direction, and is composed of grains having a crystal orientation of {110}<001>, the so-called Goss orientation.

Generally, the magnetic properties may be described by a magnetic flux density and iron loss, and a high magnetic flux density may be obtained by precisely arranging an orientation of grains in a {110}<001> orientation. The electrical steel sheet having a high magnetic flux density not only makes it possible to reduce a size of an iron core material of an electric device, but also reduces hysteresis loss, thereby achieving miniaturization and high efficiency of the electric device at the same time. Iron loss is power loss consumed as heat energy when an arbitrary alternating magnetic field is applied to a steel sheet, and it largely changes depending on a magnetic flux density and a thickness of the steel sheet, an amount of impurities in the steel sheet, specific resistance, and a size of a secondary recrystallization grain, wherein the higher the magnetic flux density and the specific resistance and the lower the thickness and the amount of impurities in the steel sheet, the lower the iron loss and the higher the efficiency of the electric device.

Currently, it is a worldwide trend to reduce the generation of CO₂ and cope with global warming by promoting energy-saving and high-efficiency commercialization, and as the demand for expanding and spreading high-efficiency electrical equipment using less electric energy is increased, the social demand for the development of a grain-oriented electrical steel sheet having low iron loss properties is increasing.

Generally, the grain-oriented electrical steel sheet having excellent magnetic properties is required to strongly develop a Goss texture in the {110}<001> orientation in the rolling direction of the steel sheet, and in order to form such a texture, the grains of the Goss orientation should form an abnormal grain growth called secondary recrystallization. This abnormal grain growth occurs when the movement of a grain boundary in which grains normally grow is inhibited by precipitates, inclusions, or elements that are dissolved or segregated in the grain boundaries, unlike ordinary crystal grain growth. As described above, the precipitates and inclusions that inhibit grain growth are specifically referred to as grain growth inhibitors, and studies on the production technology of grain-oriented electrical steel sheets by secondary recrystallization of {110}<001> orientation have been focused on securing superior magnetic properties by using a strong grain growth inhibitor to form secondary recrystallization with high integration to {110}<001> orientation.

In the conventional grain-oriented electrical steel sheet technology, precipitates such as AlN and MnS[Se] are mainly used as a grain growth inhibitor. For example, there is a manufacturing method in which, after decarburization is performed after one-time strong cold-rolling, nitrogen is supplied to the interior of the steel sheet through a separate nitriding process using ammonia gas to cause secondary recrystallization by an Al-based nitride exhibiting a strong grain growth inhibiting effect.

However, the increased instability of the precipitates due to denitriding or nitriding by the atmosphere in the furnace in the high-temperature annealing process and the necessity of the long purification annealing for 30 hours or more at a high temperature have the complication in the manufacturing process and the cost burden.

For this reason, recently, a method for manufacturing a grain-oriented electrical steel sheet without using a precipitate such as AlN or MnS as a grain growth inhibitor has been proposed. For example, there is a manufacturing method using grain boundary segregation elements such as barium (Ba) and yttrium (Y).

Ba and Y have the advantage of being excellent in the effect of inhibiting the growth of grains enough to form secondary recrystallization and being free from the influence of the atmosphere in the furnace during the high temperature annealing, but there is a disadvantage in that a large amount of a secondary compound is formed in the steel sheet such as carbides, nitrides, oxides, or Fe compounds of Ba and Y in the manufacturing process. Such a secondary compound has a problem that the iron loss property of the final product is deteriorated.

### DISCLOSURE

A grain-oriented electrical steel sheet and a manufacturing method thereof are provided. Specifically, a grain-oriented electrical steel sheet and a manufacturing method thereof that may improve magnetism by using a recrystallized grain growth inhibition effect of Ba and Y are provided.

A grain-oriented electrical steel sheet according to an embodiment of the present invention includes: in wt %, Si at 1.0 to 7.0%, Mn at 0.5% or less (excluding 0%), Al at 0.005% or less (excluding 0%), S at 0.0055% or less (excluding 0%), one or more of Ba and Y at 0.005 to 0.5%, one or more of Sn at 0.02 to 0.15%, Sb at 0.01 to 0.08%, and Ni at 0.02 to 0.5%, and the balance of Fe and inevitable impurities.

The grain-oriented electrical steel sheet may further include one or more of C at 0.005 wt % or less and N at 0.0055 wt % or less.

The grain-oriented electrical steel sheet may include Ba at 0.005 to 0.5 wt %.

The grain-oriented electrical steel sheet may include Y at 0.005 to 0.5 wt %.

The grain-oriented electrical steel sheet may include Ba and Y, and a sum content of Ba and Y are 0.005 to 0.5 wt %.

The grain-oriented electrical steel sheet may include one or more of Sn at 0.02 to 0.15 wt %, Sb at 0.01 to 0.08 wt %, and Ni at 0.02 to 0.5 wt %.

An area ratio of grains having a grain diameter of 2 mm or less may be 10% or less.

An average diameter of grains having a grain diameter of 2 mm or more may be 1 cm or more.

When viewed on a basis of a rolling vertical surface, an average angle formed by a <001> direction of a texture and a rolling direction axis may be 3.5 degrees or less.

The grain-oriented electrical steel sheet may satisfy Formula 1 below.

0.02≤(0.5×[Sn]+[Sb])<([Ba]+[Y]) [Formula 1]

(In Formula 1, [Sn], [Sb], [Ba], and [Y] mean contents (wt %) of Sn, Sb, Ba, and Y, respectively.)

A manufacturing method of a grain-oriented electrical steel sheet according to an embodiment of the present invention includes: heating a slab including: in wt %, Si at 1.0 to 7.0%, C at 0.005 to 1.0%, Mn at 0.5% or less (excluding 0%), Al at 0.005% or less (excluding 0%), S at 0.0055% or less (excluding 0%), one or more of Ba and Y at 0.005 to 0.5%, one or more of Sn at 0.02 to 0.15%, Sb at 0.01 to 0.08%, and Ni at 0.02 to 0.5%, and the balance of Fe and inevitable impurities; hot-rolling the slab to manufacture a hot-rolled sheet; cold-rolling the hot-rolled sheet to manufacture a cold-rolled sheet; primary recrystallization annealing the cold-rolled sheet; and secondary recrystallization annealing the cold-rolled sheet subjected to the primary recrystallization annealing.

In the heating of the slab, the slab may be heated at 1000 to 1280° C.

The grain-oriented electrical steel sheet may further include, after the manufacturing of the hot-rolled sheet, annealing the hot-rolled sheet at 900° C. or higher.

The primary recrystallization annealing may be performed at a temperature of 750° C. to 1000° C. for 30 seconds to 30 minutes.

The secondary recrystallization annealing may include heating and soaking, and the heating may be performed in a hydrogen atmosphere of 90 vol % or more.

The secondary recrystallization annealing may include heating and soaking, and a temperature in the soaking may be 900 to 1250° C.

The grain-oriented electrical steel sheet according to the embodiment of the present invention has excellent magnetic properties by stably forming Goss grains.

In addition, since AlN and MnS are not used as grain growth inhibitors, there is no need to heat a slab at a high temperature of 1300° C. or higher.

In addition, since it is not necessary to remove N and S, which are precipitates, a purification annealing time may be relatively shortened, and productivity may be improved.

Further, since Sn, Sb, and Ni are added, magnetism and productivity may be further improved.

### DESCRIPTION OF THE DRAWINGS

FIG. 1 illustrates a schematic perspective view of a steel sheet to explain the concept of angles of alpha (α), beta (β), and delta (δ).

### MODE FOR INVENTION

It will be understood that, although the terms first, second, third, etc. may be used herein to describe various elements, components, regions, layers, and/or sections, they are not limited thereto. These terms are only used to distinguish one element, component, region, layer, or section from another element, component, region, layer, or section. Therefore, a first part, component, area, layer, or section to be described below may be referred to as second part, component, area, layer, or section within the range of the present invention.

The technical terms used herein are to simply mention a particular embodiment and are not meant to limit the present invention. An expression used in the singular encompasses an expression of the plural, unless it has a clearly different meaning in the context. In the specification, it is to be understood that the terms such as “including”, “having”, etc., are intended to indicate the existence of specific features, regions, numbers, stages, operations, elements, components, and/or combinations thereof disclosed in the specification, and are not intended to preclude the possibility that one or more other features, regions, numbers, stages, operations, elements, components, and/or combinations thereof may exist or may be added.

When referring to a part as being “on” or “above” another part, it may be positioned directly on or above another part, or another part may be interposed therebetween. In contrast, when referring to a part being “directly above” another part, no other part is interposed therebetween.

Unless otherwise defined, all terms used herein, including technical or scientific terms, have the same meanings as those generally understood by those with ordinary knowledge in the field of art to which the present invention belongs. Terms defined in commonly used dictionaries are further interpreted as having meanings consistent with the relevant technical literature and the present disclosure, and are not to be construed as having idealized or very formal meanings unless defined otherwise.

Unless mentioned in a predetermined way, % represents wt %, and 1 ppm is 0.0001 wt %.

In embodiments of the present invention, inclusion of an additional element means replacing the remaining iron (Fe) by an additional amount of the additional elements.

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

A grain-oriented electrical steel sheet according to an embodiment of the present invention includes: in wt %, Si at 1.0 to 7.0%, Mn at 0.5% or less (excluding 0%), Al at 0.005% or less (excluding 0%), S at 0.0055% or less (excluding 0%), one or more of Ba and Y at 0.005 to 0.5%, one or more of Sn at 0.02 to 0.15%, Sb at 0.01 to 0.08%, and Ni at 0.02 to 0.5%, and the balance of Fe and inevitable impurities.

Ba and Y are elements that have a very large atomic size and are segregated at a relatively high temperature. When Sn, Sb, and Ni are added in addition to these elements, segregation occurs at a relatively low temperature, and an amount of the segregation varies depending on an annealing time, and in this case, when the annealing time is very long, segregation occurs at grain boundaries, surfaces, and interfaces even at 700° C. or lower.

In the embodiment of the present invention, when appropriate amounts of Sn, Sb, Ni, etc. are added, segregation occurs even when annealing for a short time when hot-rolled sheet annealing or primary recrystallization annealing is performed. When the annealing texture is improved through segregation at this annealing temperature, and when inhibiting ability by the auxiliary segregation of Sn and Sb is added, even if the contents of Ba and Y are not increased compared with when Ba and Y are added alone, excellent magnetism may be obtained.

In addition, when Ni is added together with Sb and Sn, the segregation of Sb and Sn may be enhanced to further increase a Goss fraction in the primary recrystallized texture.

Hereinafter, reasons for limiting the alloy components will be described.

Si at 1.0 to 7.0 wt %

Silicon (Si) is a basic composition of an electric steel sheet, and it serves to reduce core loss by increasing specific resistance of a material. When the Si content is too small, specific resistance decreases, so that iron loss characteristics may deteriorate. When too much Si is added in a slab, brittleness of the steel increases, so that cold-rolling may become difficult. Si may be included in the slab, or may be added by a diffusion method after powder coating or surface deposition. When the Si content is too high in the final electrical steel sheet, processing may become difficult when manufacturing a transformer. Therefore, in the embodiment of the present invention, Si may be included in an amount of 1.0 to 7.0 wt %. Specifically, it may be included in an amount of 2.0 to 4.5 wt %. More specifically, it may be included in an amount of 2.5 to 3.5 wt %.

Mn at 0.5 wt % or less

Manganese (Mn) is a specific resistance element and has an effect of improving magnetism, but when too much is contained, it may cause phase transformation after secondary recrystallization to adversely affect magnetism. Therefore, Mn may be included in an amount of 0.5 wt % or less. Specifically, Mn may be included in an amount of 0.01 to 0.3 wt %. More specifically, Mn may be included in an amount of 0.03 to 0.1 wt %.

Al at 0.005 wt % or less

Aluminum (Al) is combined with nitrogen in the steel to form an AlN precipitate, so in the embodiment of the present invention, an Al content is actively inhibited to avoid formation of an Al-based nitride or oxide. When such a precipitate is contained, it considerably affects a primary recrystallized grain size and thus affects the secondary recrystallization. In the embodiment of the present invention, since the secondary recrystallization is made insensitive to process variables by using only segregation elements without using precipitates, it is possible to reduce the elements forming precipitates as much as possible. When the content of Al is too large, since the formation of the AlN and Al₂O₃ is promoted, a purification annealing time for eliminating it increases, and the AlN precipitate and inclusions such as Al₂O₃ that have not been eliminated remain in a final product, which increases a coercive force, and thus the iron loss may increase. Therefore, Al may be included in an amount of 0.005 wt % or less.

S at 0.0055 wt % or leas

Sulfur (S) is an element with a high solid solution temperature and severe segregation during hot rolling, so it is desirable to prevent it from being contained as much as possible, but since it is a kind of an impurity inevitably contained during steelmaking, it is difficult to completely remove it. S is combined with Cu or Mn, which inevitably exists in the steel, to form precipitates such as CuS, MnS, and (Mn, Cu)S, which affects the primary recrystallized grain size, so S may be managed to be 0.0055 wt % or less in a quenching step. Specifically, S may be included in an amount of 0.0035 wt % or less. In the final manufactured electrical steel sheet, S may be 0.0015 wt % or less.

One or more of Ba and Y at 0.005 to 0.5 wt %

When too little of barium (Ba) and yttrium (Y) are included, it is difficult to exert the inhibiting ability of the secondary recrystallization described above. Conversely, when too much is included, rollability may be deteriorated and rolling cracks may increase. Accordingly, one or more of Ba and Y are included in an amount of 0.005 to 0.5 wt %. In the embodiment of the present invention, Ba may be included alone, Y may be included alone, or both Ba and Y may be included. When Ba is included alone, Ba may be included in an amount of 0.005 to 0.5 wt %. When Y is included alone, Y may be included in an amount of 0.005 to 0.5 wt %. When both Ba and Y are included, a sum amount of Ba and Y may be 0.005 to 0.5 wt %.

Specifically, one or more of Ba and Y may be included in an amount of 0.01 to 0.3 wt %. More specifically, one or more of Ba and Y may be included in an amount of 0.03 to 0.2 wt %.

One or more of Sn at 0.02 to 0.15 wt %, Sb at 0.01 to 0.08 wt %, and Ni at 0.02 to 0.5 wt %

Tin (Sn) not only has an effect of increasing a fraction of grains having a {110}<001> orientation in the primary recrystallized texture, but also has an effect of uniformly precipitating sulfides. In addition, when a certain amount or more of Sn is added, since an effect of inhibiting oxidation reaction during decarburization may be obtained, a temperature during decarburization may be further increased, and as a result, the primary film formation of the grain-oriented electrical steel sheet may be facilitated. In addition, since Sn may be precipitated at the grain boundaries to inhibit grain growth, a merit that the secondary recrystallization grain size may be reduced may be obtained. Therefore, it is possible to obtain an effect of magnetic domain refinement by secondary recrystallized grain refinement. When too little Sn is included, its action is difficult to be properly exhibited, and when too much Sn is contained, there is a problem that the primary recrystallized grain size becomes too small. Therefore, when Sn is included, it may be included in an amount of 0.02 to 0.15 wt %. Specifically, Sn may be included in an amount of 0.03 to 0.1 wt %.

Antimony (Sb) has an effect of increasing a fraction of grains having a {110}<001> orientation in the primary recrystallized texture, and has an effect of inhibiting excessive growth of the primary recrystallized grain by segregation at the grain boundaries. When Sb is included and when too little is included, its action is difficult to be properly exhibited. On the other hand, when too much Sb is included, the primary recrystallized grain size is excessively reduced, and thus a secondary recrystallization initiation temperature decreases, resulting in a problem of deteriorating magnetic characteristics or making decarburization difficult, or the inhibiting ability against grain growth may excessively increase, so that the secondary recrystallization may not be formed. Therefore, when Sb is included, it may be included in an amount of 0.01 to 0.08 wt %. Specifically, it may be included in an amount of 0.015 to 0.07 wt %.

Even if either Sb or Sn is added alone without Ba and Y addition, it is difficult to cause secondary recrystallization. Ba and Y are high temperature segregation elements that inhibit crystal growth to cause secondary recrystallization. On the other hand, Sn and Sb, as segregation elements, have crystal growth inhibiting ability, but they may not be segregated at a high temperature and thus lose their inhibiting ability at the high temperature, and may not maintain the inhibiting ability until secondary recrystallization occurs. When the primary recrystallized grain size is too small, the crystal growth driving power is increased, and the appropriate Ba and Y contents should be increased to cause secondary recrystallization of good orientation. That is, as the Sn+Sb content increases, the primary recrystallized grain size decreases, and the Ba+Y content needs to be increased. In other words, all of barium, yttrium, antimony, and tin inhibit crystal growth, and the contents of Sn and Sb, which have strong inhibiting ability at 800 to 900° C. at which decarburization annealing occurs, should be included to satisfy Formula 1 for the contents of Ba and Y to inhibit excessive crystal growth, so that it is possible to improve the texture while preventing excessive crystal growth inhibition.

0.02≤(0.5×[Sn]+[Sb])<([Ba]+[Y]) [Formula 1]

(In Formula 1, [Sn], [Sb], [Ba], and [Y] mean contents (wt %) of Sn, Sb, Ba, and Y, respectively.)

Ni at 0.02 to 0.5 wt %

Nickel (Ni) improves a hot-rolled sheet structure, reinforces roles of Sn and Sb to reinforce the inhibitor to increase the secondary recrystallization initiation temperature, and stably forms the secondary recrystallization to contribute to manufacturing a grain-oriented electrical steel sheet with excellent magnetic properties. As described above, when Ni is added together with Sb and Sn, the segregation of Sb and Sn may be enhanced to further increase the Goss fraction in the primary recrystallized texture. In the case of adding Ni, when too little is added, its action is difficult to be properly exhibited. In the case of adding Ni, when it is excessively contained, the primary recrystallized texture may deteriorate, so that the magnetic properties may deteriorate. Therefore, Ni may be included in an amount of 0.02 to 0.5 wt %. Specifically, it may be included in an amount of 0.03 to 0.3 wt %.

The aforementioned Sn, Sb, and Ni may each be included in the above-described range, or two or more thereof may be included. Specifically, Sn may be included alone, Sb may be included alone, or Ni may be included alone. When two or more thereof are included, Sn or Sb may be included and Ni may be included, or both Sn and Sb may be included. It is also possible to contain all of Sn, Sb, and Ni.

The grain-oriented electrical steel sheet according to the embodiment of the present invention may further include one or more of C at 0.005 wt % or less and N at 0.0055 wt % or less. As described above, when the additional elements are further included, they replace the balance of Fe.

C at 0.005 wt % or less

Carbon (C) is required in the manufacturing, but plays a detrimental role in products. As an austenite stabilizing element during the manufacturing process, it refines a coarse columnar structure occurring during a soft casting process by causing a phase change at a temperature of 900° C. or higher and inhibits a sulfur's slab center segregation. It also promotes work-hardening of the steel sheet during cold rolling, thereby promoting the formation of secondary recrystallization nuclei in {110}<001> orientation in the steel sheet. Therefore, there is no big restriction on the amount of addition, but when the slab contains too little carbon, the effect of phase transformation and process hardening may not be obtained, and when too much is added, a hot-rolled edge-crack occurs, causing problems in the work and the load of the decarburization process during decarburization annealing after cold rolling. Therefore, the C content in slab may be 0.001 to 0.1 wt %. Carbon remains at 0.005 wt % or less through the decarburization process, and specifically, it is reduced in an amount of 0.003 wt % or less. Therefore, in the embodiment of the present invention, the electrical steel sheet may further include 0.005 wt % or less of C.

N at 0.0055 wt % or less

N is an element that reacts with Al to form precipitates of AlN, (Al, Mn)N, (Al,Si,Mn)N, and Si3N4, and the formation of AlN is actively inhibited by actively inhibiting the content of Al. As described above, in the embodiment of the present invention, since it acts as an inhibitor by segregation of Ba and/or Y, no precipitate is particularly required for the secondary recrystallization.

However, when the content of N is large, it reacts with Al that is inevitably present in the steel to form AlN, so when the content thereof is excessive, the primary recrystallized grain is excessively refined, and as a result, due to the fine grains, the driving force that causes the grain growth during the secondary recrystallization increases, so that grains having an undesirable orientation may be grown, which is not preferable. Therefore, the content of N may be managed to 0.0055 wt % or less in a quenching step. Specifically, N may be included in an amount of 0.0035 wt % or less. In the final manufactured grain-oriented electrical steel sheet, N may be included in an amount of 0.0015 wt % or less.

The balance includes Fe and inevitable impurities. The inevitable impurities are impurities mixed in the steel-making and the manufacturing process of the grain-oriented electrical steel sheet, which are widely known in the field, and thus a detailed description thereof will be omitted. Specifically, components such as Ti, Mg, and Ca react with oxygen in the steel to form oxides, so it is necessary to strongly inhibit them, thus each component may be managed to 0.005 wt % or less. In the embodiment of the present invention, the addition of elements other than the above-described alloy components is not excluded, and various elements may be included within a range that does not hinder the technical concept of the present invention. When the additional elements are further included, they replace the balance of Fe.

As described above, due to the proper addition of Ba/Y and Sn/Sb/Ni, the grain diameter of the grain-oriented electrical steel sheet according to the present invention is coarsened, thereby improving magnetism. Specifically, an area ratio of grains having a grain diameter of 2 mm or less may be 10% or less. An average diameter of grains having a grain diameter of 2 mm or more may be 1 cm or more. In the embodiment of the present invention, the grain diameter means a grain diameter measured on a surface parallel to the rolling surface (ND surface). The diameter of the grain means, by assuming an imaginary circle with the same area as the grain, a diameter of the circle.

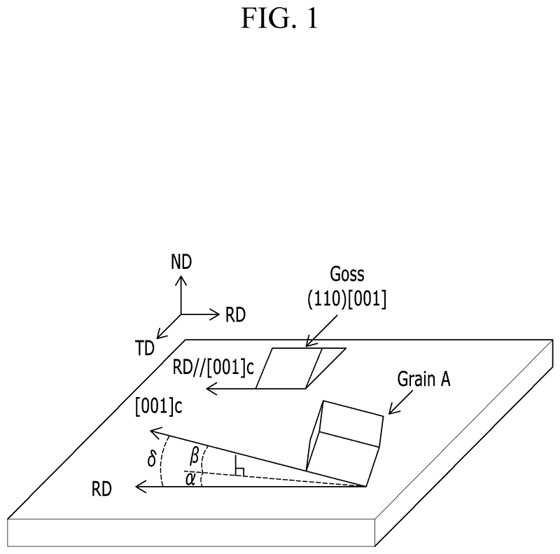

In addition, as described above, due to the appropriate addition of Ba/Y and Sn/Sb/Ni, the grains of the grain-oriented electrical steel sheet according to the present invention are accurately arranged in the Goss orientation. Specifically, when viewed on the basis of the rolling vertical surface, the average angle formed by the <001> direction of the texture with the rolling direction axis may be 3.5 degrees or less. The above angle is illustrated and described in FIG. 1. Among angles illustrated in FIG. 1, an angle (β) means an angle formed by the <001> direction of the texture with the rolling direction axis. This average angle is accurately arranged at 3.5 degrees or less, so that magnetism is improved.

The grain-oriented electrical steel sheet according to the embodiment of the present invention has particularly excellent iron loss and magnetic flux density characteristics. The magnetic flux density (B₁₀) of the grain-oriented electrical steel sheet according to the embodiment of the present invention may be 1.92 T or more. In this case, the magnetic flux density (B₁₀) is a magnetic flux density (Tesla) induced under a magnetic field of 1000 A/m. Specifically, the magnetic flux density (B₁₀) of the grain-oriented electrical steel sheet according to the embodiment of the present invention may be 1.93 T or more.

A manufacturing method of a grain-oriented electrical steel sheet according to an embodiment of the present invention includes: heating a slab including: in wt %, Si at 1.0 to 7.0%, C at 0.005 to 1.0%, Mn at 0.5% or less (excluding 0%), Al at 0.005% or less (excluding 0%), S at 0.0055% or less (excluding 0%), one or more of Ba and Y at 0.005 to 0.5%, one or more of Sn at 0.02 to 0.15%, Sb at 0.01 to 0.08%, and Ni at 0.02 to 0.5%, and the balance of Fe and inevitable impurities; hot-rolling the slab to manufacture a hot-rolled sheet; cold-rolling the hot-rolled sheet to manufacture a cold-rolled sheet; primary recrystallization annealing the cold-rolled sheet; and secondary recrystallization annealing the cold-rolled sheet subjected to the primary recrystallization annealing.

Hereinafter, respective steps will be specifically described.

First, the slab is heated.

The alloy components of the slab have been described in in the above-described grain-oriented electrical steel sheet, so a duplicate description thereof is omitted. The alloy components other than C are not substantially changed during the manufacturing process of the grain-oriented electrical steel sheet.

In the steelmaking step, as described above, it is necessary to manage the content of Al, which is an element for forming AlN precipitate and oxide, as low as possible, and an alloy element may be added as necessary. A molten steel whose components have been adjusted in the steelmaking is manufactured into a slab through continuous casting.

In the heating of the slab, the slab heating temperature is set so that it does not interfere with the slab heating conditions of other steel types. Therefore, the heating of the slab is not particularly limited. In the embodiment of the present invention, since no precipitate is used, it does not matter to use either the conventional high-temperature slab heating method at 1300° C. that does not perform nitriding, which emphasizes the heating of the slab for the control of the precipitate, or the low-temperature slab heating method lowering to 1280° C. or lower for nitriding.

However, when the slab heating temperature increases, the cost of manufacturing the steel sheet may increase, the heating furnace may need to be repaired due to the melting of the surface part of the slab, and the life of the heating furnace may be shortened, so that the slab heating temperature may be limited to 1000 to 1280° C. When the slab is heated at the above-described temperature, coarse growth of a columnar structure of the slab is prevented, so that in a subsequent hot-rolling process, it is possible to prevent cracks from occurring in a width direction of the sheet, thereby improving an actual yield.

Next, the slab is hot-rolled to manufacture the hot-rolled sheet.

The hot-rolled sheet having a thickness of 1.5 to 4.0 mm may be manufactured by the hot-rolling so as to be manufactured to a final product thickness by applying an appropriate rolling rate in the final cold-rolling.

The hot rolling temperature or the cooling temperature is not particularly limited, and with respect to an example with excellent magnetism, the hot-rolling end temperature may be set to 950° C. or less, and it may be rapidly cooled with water at 600° C. or less to be wound.

The hot-rolled sheet may be subjected to hot-rolled sheet annealing as necessary, or may be cold-rolled without being subject to the hot-rolled sheet annealing. In the case of performing the hot-rolled sheet annealing, in order to make the hot-rolled structure uniform, it may be heated at a temperature of 900° C. or higher, cracked for an appropriate time, and then cooled.

Next, the hot-rolled sheet is cold-rolled to manufacture a cold-rolled sheet.

The cold-rolling is performed by using a reverse rolling mill or a tandem rolling mill once, or using a plurality of cold rolling methods including a plurality of cold rollings or intermediate annealings to manufacture a cold-rolled sheet of the final thickness. Performing warm rolling in which the temperature of the steel sheet is maintained at 100° C. or higher during the cold-rolling may be advantageous in improving magnetism. Through the cold-rolling, the final thickness of 0.1 to 0.5 mm, more specifically 0.15 to 0.35 mm, may be obtained.

Next, the cold-rolled sheet is subjected to primary recrystallization annealing. In this case, decarburization and primary recrystallization occur. The decarburization is maintained for at least 30 seconds at a temperature of 750° C. or more so that the decarburization may occur well so that the carbon content of the steel sheet may be reduced to 0.005 wt % or less, more specifically 0.0030 wt % or less, and at the same time, an oxide layer is appropriately formed on the surface of the steel sheet. In addition to the decarburization, the deformed cold-rolled structure is recrystallized and then crystallized to an appropriate size, and in this case, the annealing temperature and the soaking time may be adjusted so that the recrystallized grains may grow.

In the primary recrystallization annealing step, the technique of using a nitride such as AlN as a grain inhibitor includes a nitriding treatment, but in the embodiment of the present invention, the nitriding treatment is not required. That is, the primary recrystallization annealing may be performed in a hydrogen and nitrogen atmosphere.

Next, the secondary recrystallization annealing is performed on the cold-rolled sheet subjected to the primary recrystallization annealing. In this case, an annealing separating agent may be applied, and the secondary recrystallization annealing may be performed.

The secondary recrystallization annealing includes heating step and soaking. The heating is a step of heating the steel sheet up to the temperature of the soaking, and the soaking is a step of maintaining the steel sheet in a certain temperature range.

In the embodiment of the present invention, the heating may be performed in a hydrogen and nitrogen mixed atmosphere. Specifically, it may be performed in a hydrogen atmosphere of 70 vol % or more. More specifically, it may be performed in a hydrogen atmosphere of 90 vol % or more. In the embodiment of the present invention, since a nitride such as AlN is not used, there is no need to protect the nitride in the heating, and even if it is performed in the hydrogen atmosphere of 90 vol % or more, magnetism does not deteriorate. In the case of using the AlN nitride as an inhibitor, when the amount of nitrogen in the atmosphere gas becomes too small, AlN quickly disappears, so the secondary recrystallization may become unstable. However, in the embodiment of the present invention, since the inhibitor is not used, the nitrogen content is sufficient as long as it finds the most optimal part for controlling surface properties. Specifically, it may be performed in a hydrogen atmosphere of 95 vol % or more. More specifically, it may be performed in a hydrogen atmosphere of 99 vol % or more.

The temperature at the soaking may be 900 to 1250° C.

In the embodiment of the present invention, since AlN and MnS precipitates are not used as a main grain growth inhibitor, the burden of purification annealing to decompose and remove AlN and MnS is reduced.

Hereinafter, a specific example of the present invention will be described. However, the following example is only a specific example of the present invention, and the present invention is not limited to the following example.

### Example 1

A slab including, in wt %, Si at 3.17%, Cat 0.0055%, Al at 0.0025%, Ba, Y, Sn, Sb, and Ni contained as shown in Table 1, and the balance of Fe and inevitable impurities was heated at 1150° C. for 90 minutes; and then it was hot-rolled; rapidly cooled to 580° C.; annealed at 580° C. for 1 hour; furnace-cooled; and then hot-rolled to manufacture a hot-rolled sheet having a thickness of 2.6 mm. The hot-rolled sheet was heated at a temperature of 1090° C., maintained at 910° C. for 90 seconds, cooled in boiling water, and then pickled. Then, it was cold-rolled to have a thickness of 0.27 mm. The cold-rolled steel sheet was heated in a furnace, and then maintained at 800 to 900° C. for 150 seconds in a mixed atmosphere with a dew point of 64° C. formed by simultaneously adding 50 vol % hydrogen and 50 vol % nitrogen to be decarburized to 0.003 wt % or less of carbon.

MgO, which is an annealing separating agent, was applied to the steel sheet, and then the secondary recrystallization annealing was performed in a coil shape. The secondary recrystallization annealing was performed in a mixed atmosphere of 25 vol % nitrogen and 75 vol % hydrogen until the temperature was raised up to 1200° C., and after reaching 1200° C., it was maintained in a 100 vol % hydrogen atmosphere for 20 hours or more and then furnace-cooled. Table 1 shows the magnetic characteristics measured in the final product for respective conditions.

TABLE 1

| Sample | | | | | | Magnetic flux | |
|---|---|---|---|---|---|---|---|
| number | Ba | Y | Sn | Sb | Ni | density | |
| (wt %) | content | content | content | content | content | (B10, Tesla) | Classification |
| 1 | 0 | 0 | 0 | 0 | 0 | 1.52 | Comparative |
| | | | | | | | Material 1 |
| 2 | 0.07 | 0 | 0 | 0 | 0 | 1.9 | Comparative |
| | | | | | | | Material 2 |
| 3 | 0.1 | 0 | 0 | 0 | 0 | 1.91 | Comparative |
| | | | | | | | Material 2 |
| 4 | 0.17 | 0 | 0 | 0 | 0 | 1.9 | Comparative |
| | | | | | | | Material 3 |
| 5 | 0.6 | 0 | 0 | 0 | 0 | Rolling crack | Comparative |
| | | | | | | occurrence | Material 4 |
| 6 | 0.1 | 0 | 0.04 | 0 | 0 | 1.93 | Inventive |
| | | | | | | | Material 1 |
| 7 | 0.1 | 0 | 0.07 | 0 | 0 | 1.93 | Inventive |
| | | | | | | | Material 2 |
| 8 | 0.1 | 0 | 0.2 | 0 | 0 | 1.85 (decarburization | Comparative |
| | | | | | | defect) | Material 5 |
| 9 | 0.1 | 0 | 0 | 0.03 | 0 | 1.93 | Inventive |
| | | | | | | | Material 3 |
| 10 | 0.1 | 0 | 0 | 0.05 | 0 | 1.93 | Inventive |
| | | | | | | | Material 4 |
| 11 | 0.1 | 0 | 0 | 0.1 | 0 | 1.80 (decarburization | Comparative |
| | | | | | | defect) | Material 6 |
| 12 | 0.1 | 0 | 0 | 0.02 | 0.05 | 1.93 | Inventive |
| | | | | | | | Material 5 |
| 13 | 0.1 | 0 | 0 | 0.02 | 0.1 | 1.93 | Inventive |
| | | | | | | | Material 6 |
| 14 | 0.1 | 0 | 0 | 0.02 | 0.2 | 1.92 | Inventive |
| | | | | | | | Material 7 |
| 15 | 0.1 | 0 | 0 | 0.02 | 0.6 | 1.87 | Comparative |
| | | | | | | | Material 7 |
| 16 | 0.09 | 0 | 0.05 | 0.02 | 0 | 1.94 | Inventive |
| | | | | | | | Material 8 |
| 17 | 0.09 | 0 | 0.06 | 0 | 0.05 | 1.94 | Inventive |
| | | | | | | | Material 9 |
| 18 | 0.09 | 0 | 0.06 | 0.02 | 0.05 | 1.95 | Inventive |
| | | | | | | | Material 10 |
| 19 | 0 | 0.07 | 0 | 0 | 0 | 1.9 | Comparative |
| | | | | | | | Material 8 |
| 20 | 0 | 0.11 | 0 | 0 | 0 | 1.9 | Comparative |
| | | | | | | | Material 9 |
| 21 | 0 | 0.21 | 0 | 0 | 0 | 1.91 | Comparative |
| | | | | | | | Material 10 |
| 22 | 0 | 0.6 | 0 | 0 | 0 | Rolling crack | Comparative |
| | | | | | | occurrence | Material 11 |
| 23 | 0 | 0.11 | 0.05 | 0 | 0 | 1.92 | Inventive |
| | | | | | | | Material 11 |
| 24 | 0 | 0.11 | 0.08 | 0 | 0 | 1.93 | Inventive |
| | | | | | | | Material 12 |
| 25 | 0 | 0.11 | 0.22 | 0 | 0 | 1.65 | Comparative |
| | | | | | | | Material 12 |
| 26 | 0 | 0.11 | 0 | 0.02 | 0 | 1.93 | Inventive |
| | | | | | | | Material 13 |
| 27 | 0 | 0.11 | 0 | 0.04 | 0 | 1.93 | Inventive |
| | | | | | | | Material 14 |
| 28 | 0 | 0.11 | 0 | 0.11 | 0 | Decarburization | Comparative |
| | | | | | | defect | Material 13 |
| 29 | 0 | 0.11 | 0 | 0.02 | 0.045 | 1.92 | Inventive |
| | | | | | | | Material 15 |
| 30 | 0 | 0.11 | 0 | 0.02 | 0.15 | 1.93 | Inventive |
| | | | | | | | Material 16 |
| 31 | 0 | 0.11 | 0 | 0.02 | 0.7 | 1.7 | Comparative |
| | | | | | | | Material 14 |
| 32 | 0 | 0.11 | 0.06 | 0.02 | 0 | 1.94 | Inventive |
| | | | | | | | Material 17 |
| 33 | 0 | 0.11 | 0.05 | 0 | 0.04 | 1.94 | Inventive |
| | | | | | | | Material 18 |
| 34 | 0 | 0.11 | 0.05 | 0.02 | 0.04 | 1.95 | Inventive |
| | | | | | | | Material 19 |
| 35 | 0.05 | 0.05 | 0 | 0 | 0 | 1.9 | Comparative |
| | | | | | | | Material 15 |
| 36 | 0.08 | 0.07 | 0 | 0 | 0 | 1.91 | Comparative |
| | | | | | | | Material 16 |
| 37 | 0.05 | 0.05 | 0.06 | 0 | 0 | 1.92 | Inventive |
| | | | | | | | Material 20 |
| 38 | 0.05 | 0.05 | 0 | 0.03 | 0 | 192 | Inventive |
| | | | | | | | Material 21 |
| 39 | 0.05 | 0.05 | 0.05 | 0.03 | 0 | 1.93 | Inventive |
| | | | | | | | Material 22 |
| 40 | 0.05 | 0.05 | 0.06 | 0.02 | 0.05 | 1.94 | Inventive |
| | | | | | | | Material 23 |

As shown in Table 1, it can be seen that the magnetism of the inventive materials appropriately containing the contents of Ba/Y and Sn/Sb/Ni are superior to that of the comparative materials. The iron loss also tends to be the same.

### Example 2

For samples containing the same components as samples 10, 16, 18, and 39 of Example 1, the same process as in Example 1 for cold rolling was performed, and the cold-rolled steel sheet was heated in a furnace, and then maintained at 800 to 900° C. for 120 seconds in a mixed atmosphere with a dew point of 60° C. formed by simultaneously adding 50 vol % hydrogen and 50 vol % nitrogen to be decarburized to 0.003 wt % or less of carbon. These samples were coated with MgO, which an annealing separating agent, and then finally annealed in a coil shape. For the final annealing, the atmosphere was set to a 100 vol % hydrogen atmosphere condition until the temperature was raised up to 1200° C., and after reaching 1200° C., it was maintained in a 100 vol % hydrogen atmosphere for 20 hours or more and then furnace-cooled. Table 2 shows the magnetic characteristics measured for respective conditions.

TABLE 2

| | | | | | | Atmosphere when | | |
|---|---|---|---|---|---|---|---|---|
| | Ba | Y | Sn | Sb | Ni | heating secondary | Magnetic | |
| Sample | content | content | content | content | content | recrystallization | flux density | |
| number | (wt %) | (wt %) | (wt %) | (wt %) | (wt %) | annealing | (B10, Tesla) | Classification |
| 10 | 0.1 | 0 | 0 | 0.05 | 0 | 100 vol % | 1.92 | Inventive |
| | | | | | | hydrogen | | Material 24 |
| 16 | 0.09 | 0 | 0.05 | 0.02 | 0 | 100 vol % | 1.93 | Inventive |
| | | | | | | hydrogen | | Material 25 |
| 18 | 0.09 | 0 | 0.06 | 0.02 | 0.05 | 100 vol % | 1.94 | Inventive |
| | | | | | | hydrogen | | Material 26 |
| 39 | 0.09 | 0 | 0.06 | 0.02 | 0.05 | 100 vol % | 1.94 | Inventive |
| | | | | | | hydrogen | | Material 27 |

Comparing the magnetisms of samples 10, 16, 18, and 39 in Table 2 and Table 1, it can be seen that the sample using Ba or Y as the main inhibitor has the same magnetism regardless of the atmospheric conditions during the heating for the secondary recrystallization annealing. That is, when Ba and Y are used as the main inhibitors, the magnetism may be stably secured regardless of the secondary recrystallization annealing atmosphere.

### Example 3

A slab including, in wt %, Si at 3.15%, C at 0.05%, Mn, S, Ba, Y, Sn, and Sb contained as shown in Table 3 below, and the balance of Fe and inevitable impurities, was heated at 1150° C. for 90 minutes; and then it was hot-rolled; rapidly cooled to 580° C.; annealed at 580° C. for 1 hour; furnace-cooled; and then hot-rolled to manufacture a hot-rolled sheet having a thickness of 2.6 mm. The hot-rolled sheet was heated at a temperature of 1050° C. or more, maintained at 910° C. for 90 seconds, quenched in boiling water, and then pickled. Then, it was cold-rolled to have a thickness of 0.262 mm. The cold-rolled steel sheet was heated in a furnace, and then maintained at 800 to 900° C. for 120 seconds in a mixed atmosphere with a dew point of 60° C. formed by simultaneously adding 50 vol % hydrogen and 50 vol % nitrogen to be decarburized to 0.003 wt % or less of carbon.

MgO, which is an annealing separating agent, was applied to the steel sheet, and then the secondary recrystallization annealing was performed in a coil shape. The secondary recrystallization annealing was performed in a mixed atmosphere of 25 vol % nitrogen and 75 vol % hydrogen until the temperature was raised up to 1200° C., and after reaching 1200° C., it was maintained in a 100 vol % hydrogen atmosphere for 20 hours or more and then furnace-cooled. Table 3 shows the magnetic characteristics measured for respective conditions.

TABLE 3

| Ba | Y | Sn | Sb | Mn | S | Magnetic | |
|---|---|---|---|---|---|---|---|
| content | content | content | content | content | content | flux density | |
| (wt %) | (wt %) | (wt %) | (wt %) | (wt %) | (wt %) | (B₁₀, Tesla) | Classification |
| 0.12 | 0 | 0.06 | 0.02 | 0.05 | 0 | 1.92 | Inventive |
| | | | | | | | Material 28 |
| 0 | 0.1 | 0.06 | 0.02 | 0.05 | 0 | 1.94 | Inventive |
| | | | | | | | Material 29 |
| 0.12 | 0 | 0.06 | 0.02 | 0.9 | 0 | 1.55 | Comparative |
| | | | | | | | Material 17 |
| 0.12 | 0 | 0.06 | 0.025 | 0.05 | 0.002 | 1.93 | Inventive |
| | | | | | | | Material 30 |
| 0.12 | 0 | 0.06 | 0.025 | 0.05 | 0.01 | 1.54 | Comparative |
| | | | | | | | Material 18 |
| 0 | 0.1 | 0.07 | 0.02 | 0.05 | 0.002 | 1.93 | Inventive |
| | | | | | | | Material 31 |
| 0 | 0.1 | 0.07 | 0.02 | 0.05 | 0.01 | 1.55 | Comparative |
| | | | | | | | Material 19 |

As shown in Table 3, when Mn and S are contained in an excessive amount, it can be confirmed that the magnetism is deteriorated.

### Example 4

A slab including, in wt %, Si at 3.18%, C at 0.054%, Sn at 0.05%, Sb at 0.025%, Ni at 0.045%, Ba and Y contained as shown in Table 4 below, and the balance of Fe and inevitable impurities was heated at 1150° C. for 100 minutes; and then it was hot-rolled; rapidly cooled to 580° C.; annealed at 580° C. for 1 hour; furnace-cooled; and then hot-rolled to manufacture a hot-rolled sheet having a thickness of 2.6 mm. The hot-rolled sheet was heated at a temperature of 1050° C. or more, maintained at 910° C. for 90 seconds, quenched in boiling water, and then pickled. Then, it was cold-rolled to have a thickness of 0.262 mm. The cold-rolled steel sheet was heated in a furnace, and then maintained at 800 to 900° C. for 120 seconds in a mixed atmosphere with a dew point of 67° C. formed by simultaneously adding 75 vol % hydrogen and 25 vol % nitrogen to be decarburized to 0.003 wt % or less of carbon.

This steel sheet was coated with MgO, which an annealing separating agent, and then finally annealed in a coil shape. The final annealing was performed in a mixed atmosphere of 25 vol % nitrogen and 75 vol % hydrogen until the temperature was raised to 1200° C., and after reaching 1200° C., it was maintained in a 100 vol % hydrogen atmosphere for 20 hours or more and then furnace-cooled. Table 4 shows the magnetic characteristics measured for respective conditions.

TABLE 4

| | | | | Average angle | | |
|---|---|---|---|---|---|---|
| | | Area fraction | Average diameter | formed by <001> | | |
| Ba | Y | (%) of grain | (mm) of grains | orientation | Magnetic | |
| content | content | with grain diameter | with grain diameter | and rolling | flux density | |
| (wt %) | (wt %) | of 2 mm or less | of 2 mm or more | direction axis | (B₁₀, Tesla) | Classification |
| 0 | 0 | 100 | — | — | 1.55 | Comparative |
| | | | | | | Material 20 |
| 0 | 0.085 | 3 | 24 | 2.3 | 1.93 | Inventive |
| | | | | | | Material 31 |
| 0 | 0.6 | 91 | 6 | 6 | 1.81 | Comparative |
| | | | | | | Material 21 |

As shown in Table 4, by using Ba and Y, when the area ratio of grains having a grain size of 2 mm or less is set to 10% or less, the average size of grains of 2 mm or more is set to 1 cm or more, and the average angle formed by the <001> direction and the rolling axis is set to be a certain value or less, it can be confirmed that the magnetism is excellent.

The present invention may be embodied in many different forms, and should not be construed as being limited to the disclosed embodiments and/or examples. In addition, it will be understood by those skilled in the art that various changes in form and details may be made thereto without departing from the technical spirit and essential features of the present invention. Therefore, it is to be understood that the above-described embodiments and/or examples are for illustrative purposes only, and the scope of the present invention is not limited thereto.

1. A grain-oriented electrical steel sheet including: in wt %, Si at 1.0 to 7.0%, Mn at 0.5% or less (excluding 0%), Al at 0.005% or less (excluding 0%), S at 0.0055% or less (excluding 0%), one or more of Ba and Y at 0.005 to 0.5%, and
one or more of Sn at 0.02 to 0.15%, Sb at 0.01 to 0.08%, and Ni at 0.02 to 0.5%, and the balance of Fe and inevitable impurities.

2. The grain-oriented electrical steel sheet of claim 1, further comprising
one or more of C at 0.005 wt % or less and N at 0.0055 wt % or less.

3. The grain-oriented electrical steel sheet of claim 1, wherein
the grain-oriented electrical steel sheet includes Ba at 0.005 to 0.5 wt %.

4. The grain-oriented electrical steel sheet of claim 1, wherein
the grain-oriented electrical steel sheet includes Y at 0.005 to 0.5 wt %.

5. The grain-oriented electrical steel sheet of claim 1, wherein
the grain-oriented electrical steel sheet includes Ba and Y, and a sum content of Ba and Y are 0.005 to 0.5 wt %.

6. The grain-oriented electrical steel sheet of claim 1, wherein
the grain-oriented electrical steel sheet includes one or more of Sn at 0.02 to 0.15 wt %, Sb at 0.01 to 0.08 wt %, and Ni at 0.02 to 0.5 wt %.

7. The grain-oriented electrical steel sheet of claim 1, wherein
an area ratio of grains having a grain diameter of 2 mm or less is 10% or less.

8. The grain-oriented electrical steel sheet of claim 1, wherein
an average diameter of grains having a grain diameter of 2 mm or more is 1 cm or more.

9. The grain-oriented electrical steel sheet of claim 1, wherein
when viewed on a basis of a rolling vertical surface, an average angle formed by a <001> direction of a texture and a rolling direction axis is 3.5 degrees or less.

10. The grain-oriented electrical steel sheet of claim 1, wherein
the grain-oriented electrical steel sheet satisfies Formula 1:
0.02≤(0.5×[Sn]+[Sb])<([Ba]+[Y]) [Formula 1]
(in Formula 1, [Sn], [Sb], [Ba], and [Y] mean contents (wt %) of Sn, Sb, Ba, and Y, respectively).

11. A manufacturing method of a grain-oriented electrical steel sheet, comprising:
heating a slab including: in wt %, Si at 1.0 to 7.0%, C at 0.005 to 1.0%, Mn at 0.5% or less (excluding 0%), Al at 0.005% or less (excluding 0%), S at 0.0055% or less (excluding 0%), one or more of Ba and Y at 0.005 to 0.5%, one or more of Sn at 0.02 to 0.15%, Sb at 0.01 to 0.08%, and Ni at 0.02 to 0.5%, and the balance of Fe and inevitable impurities;
hot-rolling the slab to manufacture a hot-rolled sheet;
cold-rolling the hot-rolled sheet to manufacture a cold-rolled sheet;
primary recrystallization annealing the cold-rolled sheet; and
secondary recrystallization annealing the cold-rolled sheet subjected to the primary recrystallization annealing.

12. The manufacturing method of the grain-oriented electrical steel sheet of claim 11, wherein
in the heating of the slab, the slab is heated at 1000 to 1280° C.

13. The manufacturing method of the grain-oriented electrical steel sheet of claim 11, further comprising
after the manufacturing of the hot-rolled sheet, annealing the hot-rolled sheet at 900° C. or higher.

14. The manufacturing method of the grain-oriented electrical steel sheet of claim 11, wherein
the primary recrystallization annealing is performed at a temperature of 750° C. to 1000° C. for 30 seconds to 30 minutes.

15. The manufacturing method of the grain-oriented electrical steel sheet of claim 11, wherein
the secondary recrystallization annealing includes heating and soaking, and
the heating is performed in a hydrogen atmosphere of 90 vol % or more.

16. The manufacturing method of the grain-oriented electrical steel sheet of claim 11, wherein
the secondary recrystallization annealing includes heating and soaking, and
a temperature in the soaking is 900 to 1250° C.
